(19) United States
(12) Patent Application Publication
(10) Pub. No.: US 2011/0148594 A1
(43) Pub. Date: Jun. 23, 2011

(54) RFID SYSTEM

(75) Inventor: Hee Bok KANG, Cheongju (KR)

(73) Assignee: Hynix Semiconductor Inc., Icheon (KR)

(21) Appl. No.: 12/792,531

(22) Filed: Jun. 2, 2010

(30) Foreign Application Priority Data
Dec. 23, 2009 (KR) 10-2009-0129397

(51) Int. Cl. H04Q 5/22

(52) U.S. Cl. 340/10.3

(57) ABSTRACT

An RFID system controls a device using a serial interface protocol through the use of a wireless communication scheme thereof. The RFID system includes: a digital unit configured to control the command signal generated according to a radio signal, and generate an address, data, and a control signal; a memory unit configured to perform a data read or write operation according to the control signal applied from the digital unit; a coupling unit coupled to an external driving device; a decoder configured to decode an output data of the memory unit; and a driving controller configured to sequentially output decoded data of the decoder to the coupling unit in synchronization with a serial clock.

### CROSS-REFERENCE TO RELATED APPLICATION

The priority based on Korean patent application No. 10-2009-129397, filed on Dec. 23, 2009, the disclosure of which is hereby incorporated in its entirety by reference, is claimed.

### BACKGROUND OF THE INVENTION

Embodiments in accordance with the present invention relates to a radio frequency identification (RFID) system, and more specifically, to an RFID tag technology which is capable of automatically identifying an object by communicating with an external reader through transmission/reception of a radio signal.

An RFID is a contactless identification technology which can automatically identify an object by using a radio signal. Specifically, an RFID tag is attached to an object to be identified, and the RFID tag communicates with an RFID reader through transmission/reception of a radio signal. In this manner, the identification of the object is achieved. The use of the RFID can overcome the shortcomings of a conventional automatic identification technology, such as a barcode and an optical character recognition technology.

In recent years, RFID tags have been used in various fields, such as a distribution management system, a user authentication system, an electronic cash system, a traffic system, and so on.

For example, a distribution management system performs a commodity classification or an inventory management by using integrated circuit (IC) tags (in which data are recorded) instead of a delivery statement or tag. In another example, a user authentication system performs a room management by using IC cards in which personal information is recorded.

Meanwhile, a memory used in the RFID tag may be implemented with a nonvolatile ferroelectric memory.

In general, a nonvolatile ferroelectric memory (i.e., a ferroelectric random access memory (FeRAM)) is considered by many as a next generation storage device because it has a data processing speed similar to that of a dynamic random access memory (DRAM) and data is retained even when power is interrupted.

The FeRAM has a structure substantially similar to that of the DRAM but uses a ferroelectric capacitor as a storage element. Ferroelectric has a high remnant polarization characteristic. As a result, data is not erased even though an electric field is removed.

FIG. 1 illustrates an overall structure of a general RFID device.

The RFID device includes an antenna unit 1, an analog unit 10, a digital unit 20, and a memory unit 30.

The antenna unit 1 receives a radio signal transmitted from an external RFID reader. The radio signal received through the antenna unit 1 is inputted to the analog unit 10 through antenna pads 11 and 12.

The analog unit 10 amplifies the inputted radio signal and generates a power supply voltage VDD which can then be used as a driving voltage of an RFID tag. The analog unit 10 detects an operation command signal CMD from the inputted radio signal, and outputs the command signal CMD to the digital unit 20. In addition, the analog unit 10 detects the output voltage VDD and outputs a power on reset signal POR and a clock CLK to the digital unit 20. The power on reset signal POR is a signal which controls a reset operation.

The digital unit 20 receives the power supply voltage VDD, the power on reset signal POR, the clock CLK, and the command signal CMD from the analog unit 10, and outputs a response signal RP to the analog unit 10. In addition, the digital unit 20 outputs an address ADD, an input/output data I/O, a control signal CTR, and the clock CLK to the memory unit 30.

The memory unit 30 reads, writes and stores data by using a memory device.

The RFID device uses several frequency bands, and the device characteristics vary depending on the frequency bands. In general, as the frequency band is lowered, the recognition speed of the RFID device becomes slower, and the RFID device operates with a shorter distance and is less influenced by the environment. On the other hand, as the frequency band becomes higher, the recognition speed of the RFID device becomes faster, and the RFID device operates at a longer distance and is greatly influenced by the environment.

### BRIEF SUMMARY OF THE INVENTION

Various embodiments of the present invention are directed to providing an RFID system which can control display devices such as light emitting diodes (LEDs) through an RFID chip by coupling the display devices to the RFID chip.

Various embodiments of the present invention are directed to providing an RFID system which can control a serial interface device by using a wireless communication scheme of an RFID.

In an embodiment of the present invention, a radio frequency identification (RFID) system includes: a digital unit configured to generate an address, data, and a control signal based on a command signal generated from a radio signal; a memory unit configured to perform a data read or write operation based on the address, the data and the control signal output by the digital unit; the memory unit having a first address area to store first data for transmitting and receiving the radio signal and a second address area to store second data for controlling the driving device; a coupling unit coupled to an external driving device; a decoder configured to decode the second data outputted from the memory unit; and a driving controller configured to sequentially output decoded data of the decoder to the coupling unit in synchronization with a serial clock.

### BRIEF DESCRIPTION OF THE DRAWINGS

FIG. 1 is a block diagram of a general RFID device.

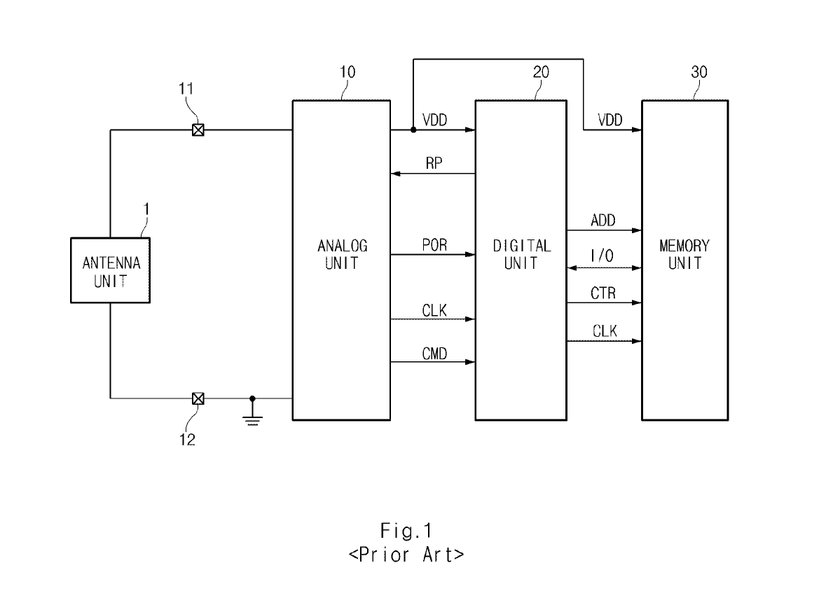

FIG. 2 is a block diagram of an RFID system according to an embodiment of the present invention.

FIG. 3 is a flowchart illustrating an operation of changing an RFID protocol to a serial protocol in the RFID system according to an embodiment of the present invention.

FIG. 4 is a diagram showing a serial protocol operation in the RFID system according to an embodiment of the present invention.

FIG. 5 is a diagram showing a detailed configuration of the serial protocol in the RFID system according to an embodiment of the present invention.

FIGS. 6 and 7 are diagrams showing read and write mode operations of the serial protocol in the RFID system according to an embodiment of the present invention.

FIG. 8 is a block diagram showing the configuration of the RFID system according to an embodiment of the present invention.

### DESCRIPTION OF EMBODIMENTS

Description of the embodiments of the present invention will now be made in detail with reference to the accompanying drawings. Wherever possible, the same reference numbers will be used throughout the drawings to refer to the same or like elements.

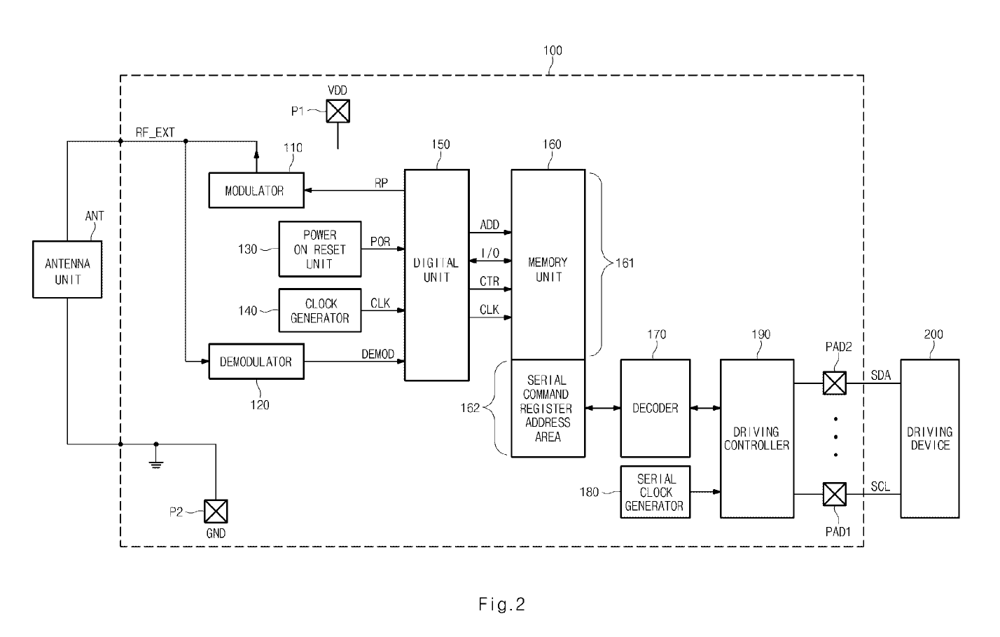

FIG. 2 is a block diagram of an RFID system according to an embodiment of the present invention.

An RFID chip 100 is coupled to an antenna unit ANT. The RFID chip 100 includes a modulator 110, a demodulator 120, a power on reset unit 130, a clock generator 140, a digital unit 150, a memory unit 160, a decoder 170, a serial clock generator 180, a driving controller 190, a clock pad PAD1, a data pad PAD2, a power supply voltage (VDD) pad P1, and a ground voltage (GND) pad P2. The clock pad PAD1 and the data pad PAD2 are coupled to an external driving device 200.

As illustrated in FIG. 2, the concept of the “RFID system” defined in the title of the invention includes the RFID chip 100 and the driving device 200.

First, the antenna unit ANT receives an external radio signal RF_EXT transmitted from an external RFID reader and transmits the external radio signal RF_EXT to the RFID chip 100. The external radio signal RF_EXT transmitted to the RFID chip 100 through the antenna unit ANT is inputted to the demodulator 120 through an antenna pad.

Meanwhile, the antenna unit ANT transmits an internal radio signal received from the RFID chip 100 to the external RFID reader. That is, the internal radio signal applied from the modulator 110 to the antenna unit ANT is transmitted to the external RFID reader through the antenna pad.

The demodulator 120 generates a command signal DEMOD by demodulating the external radio signal RF_EXT applied from the antenna unit ANT, and outputs the command signal DEMOD to the digital unit 150. The modulator 110 generates the internal radio signal by modulating a response signal RP applied from the digital unit 150, and outputs the internal radio signal to the antenna unit ANT.

Furthermore, the power on reset unit 130 detects a voltage level of a power supply voltage VDD generated at the power supply voltage pad P1, and outputs a power on reset signal POR to the digital unit 150. The power on reset signal POR is a signal which controls a reset operation.

The power on reset signal POR rises with the power supply voltage while the power supply voltage goes from a low level to a high level. The power on reset signal POR then changes from a high level to a low level at the moment that the power supply voltage reaches the power supply voltage level VDD, thereby resetting an internal circuit of the RFID chip 100.

The clock generator 140 supplies the digital unit 150 with a clock CLK which controls the operation of the digital unit 150, depending on the power supply voltage VDD generated at the power supply voltage pad P1.

In this embodiment, the RFID chip 100 is driven by the external power supply voltage pad P1 and the external ground voltage pad P2. In a conventional RFID device, an RFID tag receives a radio signal through communication with the RFID reader, and the power supply voltage is supplied through a voltage amplification unit provided inside the RFID tag.

In this embodiment, however, a large amount of power is consumed because the RFID chip 100 is coupled to the external driving device 200. Accordingly, in this embodiment, the power supply voltage VDD and the ground voltage GND are supplied to the RFID chip 100 through the additional external power supply voltage pad P1 and the additional ground voltage pad P2.

In addition, the digital unit 150 receives the power supply voltage VDD, the power on reset signal POR, the clock CLK, and the command signal DEMOD, interprets the command signal DEMOD, and generates a control signal and processing signals. The digital unit 150 outputs the response signal RP corresponding to the control signal and the processing signals to the modulator 110. Also, the digital unit 150 outputs an address ADD, data I/O, the control signal CTR, and the dock CLK to the memory unit 160.

The memory unit 160 includes a FeRAM (nonvolatile ferroelectric memory) address area 161 which stores data for transmitting and receiving the radio signal RF_EXT, and a serial command register address area 162 which stores command data for controlling the driving device 200.

In the memory unit 160, the FeRAM address area 161 includes a plurality of memory cells, each of which reads and writes data to a storage element.

The FeRAM has a data processing speed similar to that of a DRAM. Also, the FeRAM has a structure substantially similar to that of the DRAM. Since ferroelectric material is used as a capacitor, the FeRAM has a high remnant polarization which is a characteristic of the ferroelectric material. Due to such a remnant polarization characteristic, data is not erased even though an electric field is removed.

The serial command register address area 162 includes a serial command register which stores the command data in a serial data format. That is, in addition to the FeRAM address area 161 for storing a unique ID of the RFID chip 100 according to a general radio signal, the serial command register address area 162 is provided to store a driving command for controlling the driving device 200 in the serial data format.

The decoder 170 is coupled to the serial command register address area 162, and decodes output data of the serial command register address area 162. The serial dock generator 180 generates and outputs a serial clock to the driving controller 190.

The driving controller 190 is coupled between the decoder 170 and the pads PAD1 and PAD2. The driving controller 190 outputs data outputted from the decoder 170 to the data pad PAD2 in synchronization with the serial clock generated from the serial clock generator 180.

The serial interface signal applied through the driving controller 190 is outputted to the data pad PAD2 in order to control the operation of the driving device 200. The driving device 200 is coupled to the driving controller 190 of the RFID chip 100 through the clock pad PAD1 and the data pad PAD2.

The clock pad PAD1 and the data pad PAD2 are coupled to the external driving device 200 though connection pins. The connection pins correspond to a coupling unit which couples the RFID chip 100 and the driving device 200 to each other. The serial interface signal outputted from the clock pad PAD1 and the data pad PAD2 is inputted to the driving device 200. The clock pad PAD1 and the data pad PAD2 are configured to transmit a serial interface signal (using an inter-integrated circuit (I2C) bus) applied from the external driving device 200 to the driving controller 190.

The driving device 200 corresponds to a driving control device which controls an operation of a display device such as an LED, a motor, or a speaker. A case in which the driving device 200 controls a display device such as the LED will be described below as an embodiment of the present invention.

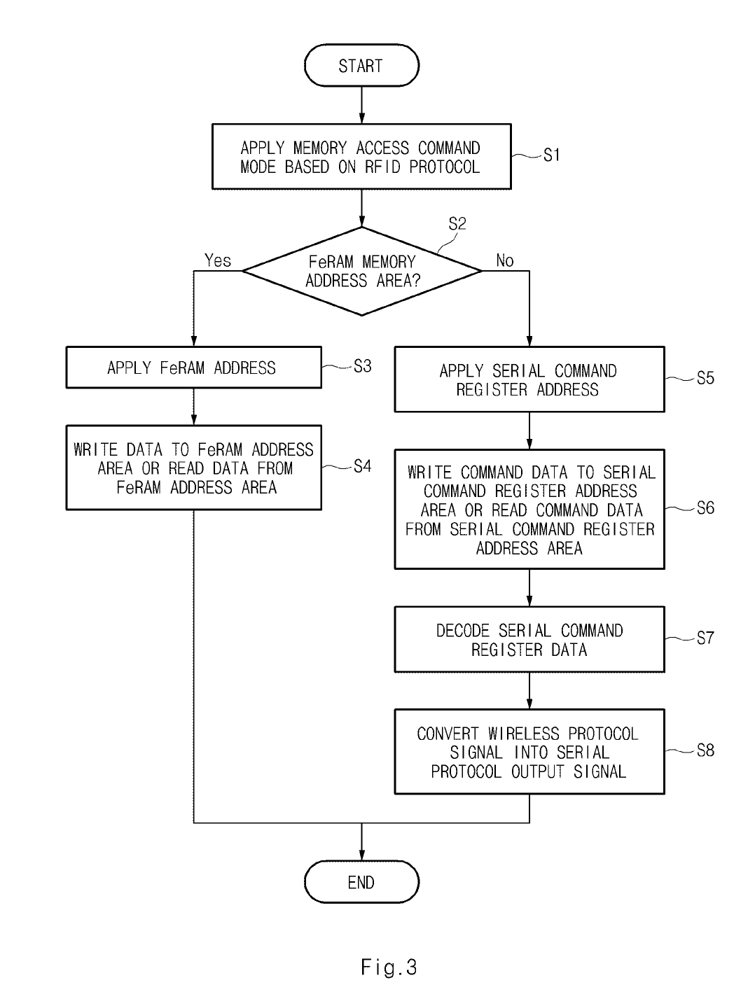

FIG. 3 is a flowchart showing an operation of converting an RFID protocol into a serial protocol in the RFID system according to an embodiment of the present invention.

First, the radio signal RF_EXT applied through the antenna unit ANT is inputted to the demodulator 120. The demodulator 120 decodes the radio signal RF_EXT and outputs the command signal DEMOD to the digital unit 150. Accordingly, a memory access command mode is inputted to the digital unit 150 based on the RFID protocol (step S1).

Then, the digital unit 150 outputs the address ADD, which is generated by interpreting the command signal DEMOD applied from the demodulator 120, the input/output data I/O, the control signal CTR, and the clock CLK to the memory unit 160.

When the memory access command mode is activated by the radio signal RF_EXT, the digital unit 150 interprets the command signal DEMOD and determines whether the memory access mode corresponds to the FeRAM address area 161 (step S2).

When the command signal DEMOD applied to the digital unit 150 involves a nonvolatile ferroelectric memory access mode, a FeRAM address is applied to the memory unit 160 (step S3).

In this case, the FeRAM address area 161 of the memory unit 160 is activated. Accordingly, a data write or read operation is performed on the FeRAM address area 161 (step S4).

On the other hand, when the command signal DEMOD applied to the digital unit 150 is not the nonvolatile ferroelectric memory access mode but a serial command register access mode, a serial command register address is applied to the memory unit 160 (step S5).

In this case, the serial command register address area 162 of the memory unit 160 is activated. Accordingly, the write or read operation of the command data is performed on the serial command register address area 162 (step S6).

Then, serial command register data stored in the serial command register address area 162 is outputted to the decoder 170. The decoder 170 decodes the serial command register data and outputs the decoded serial command register data to the driving controller 190 (step S7).

Subsequently, the driving controller 190 sequentially outputs output data SDA of the decoder 170 to the driving device 200 in synchronization with a serial clock SCL generated from the serial clock generator 180. Accordingly, the wireless protocol signal based on the RFID is converted into the serial protocol signal and outputted to the external driving device 200 (step S8).

Meanwhile, Table 1 below shows an RFID protocol command code set for processing the serial protocol in an embodiment of the present invention.

TABLE 1

| CMD Symbol | CMD description |
|---|---|
| S | Start Condition of CMD Code |
| Sr | Repeat Condition of CMD Code |
| R | Bit (1) CMD Code Read |
| W | Bit (0) CMD Code Write |
| A | Acknowledge CMD Code (SDA high) |
| A bar | Not Acknowledge CMD Code (SDA low) |
| P | Stop Condition of CMD Code |
| Slave Address | 7-bit Address (MSB first) CMD Code |
| Register Address | 8-bit Register Address CMD Code |
| Data Master | CMD Code Applied from Master |
| Data Slave | CMD Code Applied from Slave |

The operation procedures of the RFID system according to an embodiment of the present invention, which has the above-described configuration, will be described below with reference to Table 1 above.

The serial protocol implements a variety of serial interface commands by signal waveforms of the serial clock SCL and the serial data SDA. The serial protocol may use an I2C protocol.

In general, a wireless communication scheme of a conventional RFID device includes a single communication line. Accordingly, in the conventional RFID device, it is difficult to simultaneously implement the serial clock SCL and the serial data SDA by directly using the radio signal RF.

Therefore, in this embodiment, the serial interface command by the serial clock SCL and the serial data SDA is converted into the RFID protocol command code set. Using these codes, the RFID device 100 processes the serial interface signal according to the serial clock SCL and the serial data SDA.

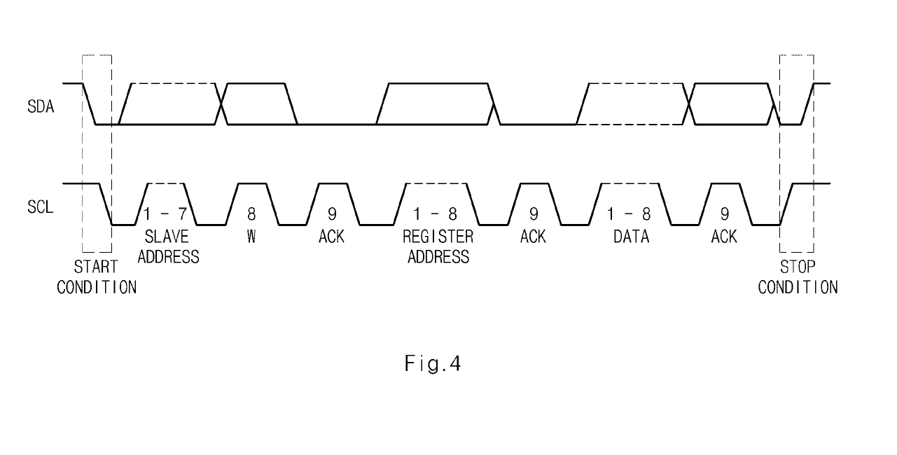

FIG. 4 is a diagram showing the operation of the serial protocol (I2C) in the RFID system according to an embodiment of the present invention.

The serial clock generator 180 generates and outputs the serial clock SCL to the driving controller 190. The driving controller 190 sequentially outputs the output of the decoder 170 to the external driving device 200 in synchronization with the serial clock SCL.

At this time, when the serial data SDA changes to a low level at the time where the serial clock SCL changes to a low level, a command code becomes a start condition.

After a 7-bit slave address is applied, a command code for writing a bit ‘0’ command code is outputted to the driving controller 190.

Subsequently, when an acknowledge (ACK) signal is activated after an 8-bit register address is applied, 8-bit data is outputted to the driving controller 190.

Subsequently, when the serial data SDA changes to a high level at the time where the serial clock SCL becomes a high level, the command code becomes a stop condition.

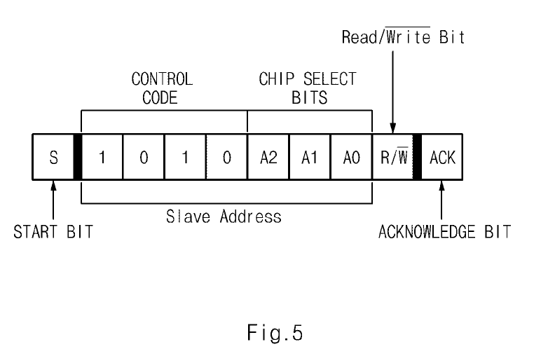

FIG. 5 is a diagram showing a detailed configuration of the serial protocol (I2C) in the RFID system according to an embodiment of the present invention.

In FIG. 5, ‘S’ represents a start bit. ‘1, 0, 1, 0, A2, A1, A0’ represents a 7-bit slave address. In the slave address, ‘1, 0, 1, 0’ represents a control code, and ‘A2, A1, A0’ represents a chip select bit.

The control code represents a code which determines a device type, and the chip select bit is a bit which can expand an address area.

R and /W represent a read bit and a write bit, respectively, and ‘ACK’ represents an acknowledge bit.

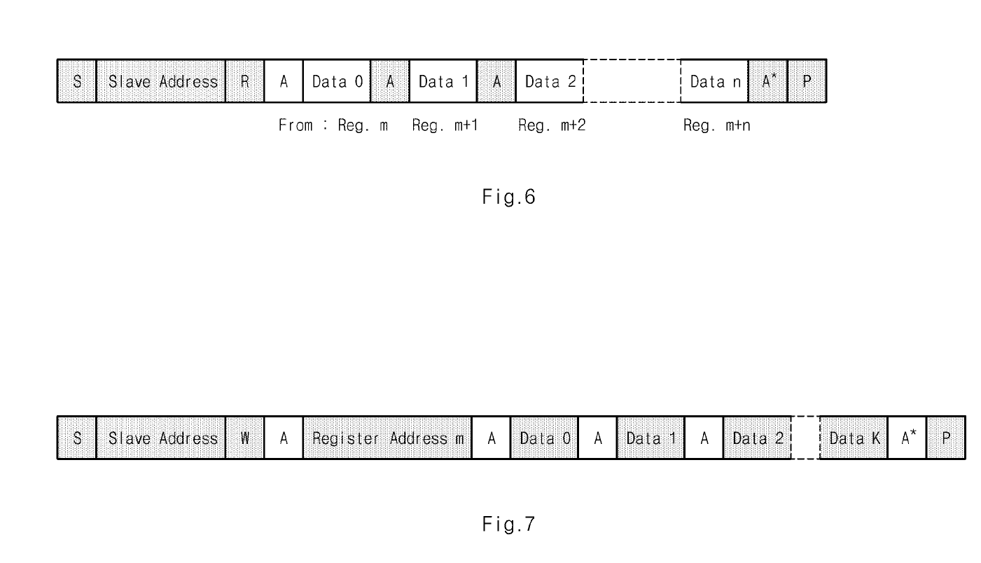

FIG. 6 is a diagram showing a read mode operation of the serial protocol (I2C) in the RFID system according to an embodiment of the present invention.

When the serial protocol mode starts (S), the slave address is outputted. When a read command (R) is inputted, ‘data 0’ stored in an mth register of the serial command register address area 162 is outputted to the decoder 170 after an acknowledge (A) command is applied. The decoder 170 decodes the ‘data 0’ and outputs the decoded data 0 to the driving controller 190.

Subsequently, after the acknowledge (A) command is applied, ‘data 1’ stored in the (m+1)th register of the serial command register address area 162 is outputted to the decoder 170. The decoder 170 decodes the ‘data 1’ and outputs the decoded data 1 to the driving controller 190.

Then, after the acknowledge (A) command is applied, ‘data 2’ stored in the (m+2)th register of the serial command register address area 162 is outputted to the decoder 170. The decoder 170 decodes the ‘data 2’ and outputs the decoded data 2 to the driving controller 190.

Then, after the acknowledge (A) command is applied, ‘data n’ stored in the (m+n)th register of the serial command register address area 162 is outputted to the decoder 170. The decoder 170 decodes the ‘data n’ and outputs the decoded data n to the driving controller 190.

The driving controller 190 sequentially outputs the data applied from the decoder 170 to the external driving device 200 in synchronization with the serial clock SCL.

FIG. 7 is a diagram showing a write mode operation of the serial protocol (I2C) in the RFID system according to an embodiment of the present invention.

When the serial protocol mode starts (S), the slave address is inputted. When a write command (W) is inputted, ‘data 0’, ‘data 1’, ‘data 2’, and ‘data k’ are sequentially written to the mth register of the serial command register address area 162 after an acknowledge (A) command is applied.

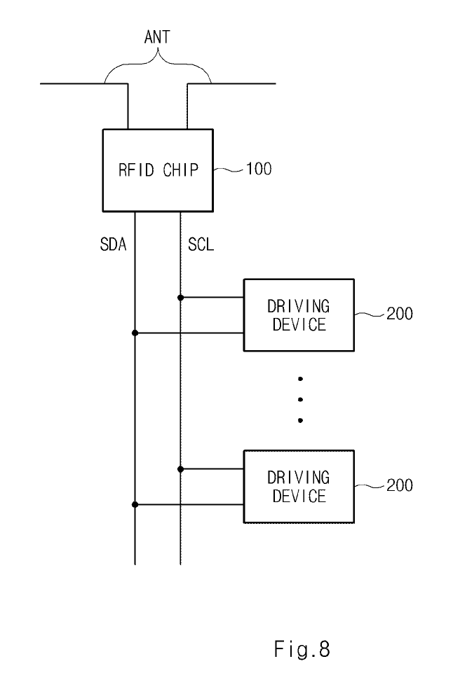

FIG. 8 is a block diagram showing the configuration of the RFID system according to an embodiment of the present invention.

The RFID chip 100 is coupled to a plurality of external driving devices 200. The RFID chip 100 and the driving devices 200 are coupled to each other through a serial clock (SCL) line and a serial data (SDA) line.

In this embodiment configured as above, the RFID chip 100 changes the RF protocol into the serial interface (I2C) protocol, and outputs the serial interface (I2C) protocol to the external driving device 200. In order to change the RF protocol to the serial interface (I2C) protocol, the RFID chip 100 combines the command signals and stores the combined command signals in the register of the serial command register address area 162.

The RFID chip 100 stores the command signals and the data in the serial command register address area 162 by using the radio signal RF_EXT.

For example, information such as LED control patterns are stored in a corresponding address area of the serial command register address area 162.

That is, each register of the serial command register address area 162 includes a data storage area for controlling the on/off operation of the display device such as an LED. Also, each register includes a diming data storage area for adjusting the brightness of each light in the display device such as the LED. Furthermore, each register includes a data storage area for controlling a progress pattern in the display device such as an LED.

As described above, the RFID chip 100 stores the command signals controlling the driving of the driving device 200 and the data corresponding to the command signals in the register. The driving controller 190 sequentially outputs the command signals and the data stored in the serial command register address area 162 to the driving device 200.

Accordingly, when the external driving device 200 coupled to the RFID chip 100 uses the serial interface protocol, the compatibility with the external driving device 200 is achieved by changing the internal wireless protocol to the serial interface protocol, without additional conversion circuitry.

In this embodiment, the command signals for controlling the driving device 200 are stored in the memory unit 160. That is, an additional digital circuit is required in order to store the serial data applied through the driving device 200 in the memory of the RFID chip 100. In this embodiment, the memory capacity is increased by additionally providing the serial command register address area 162 in the memory unit 160, without the additional digital circuit, and the driving command signals are stored in the serial command register address area 162.

In recent years, lighting installed in buildings are using a plurality of LEDs. In this case, a specific light pattern can be provided by individually controlling on/off operations of the LEDs. Furthermore, a desired brightness can be provided by controlling individual LEDs among the plurality of lights, or lights positioned at desired locations can be separately controlled.

In the above-described lighting controlling method, the lighting can be remotely controlled through the RFID device. Specifically, an RFID tag is attached to an LED device, and a desired signal is transmitted over a radio frequency through an external reader. The RFID tag attached to the LED device recognizes the transmitted signal and receives a separate command according to a unique ID. In this way, the number and brightness of the LEDs can be controlled as desired.

Such an RFID tag is relatively cheaper than a general wireless remote controller. Hence, in a case where the RFID tag is applied to the lightings or the like, the implementation costs can be reduced and more options can be provided to users.

The embodiments of the present invention have the following effects.

First, the display devices such as LEDs can be remotely controlled by the RFID chip by coupling the display devices to the RFID chip.

Second, since the serial interface device is controlled by using the wireless communication scheme of the RFID, the device using the serial interface protocol can be easily controlled by using the RFID chip.

The above embodiments of the present invention are illustrative and not limitative. Various alternatives and equivalents are possible. Other additions, subtractions, or modifications are obvious in view of the present disclosure and are intended to fall within the scope of the appended claims.

What is claimed is:

1. A radio frequency identification (RFID) system comprising:
a digital unit configured to generate an address, data, and a control signal based on a command signal generated from a radio signal;
a memory unit configured to perform a data read or write operation based on the address, the data and the control signal output by the digital unit, the memory unit having a first address area to store first data for transmitting and receiving the radio signal and a second address area to store second data for controlling the driving device;
a coupling unit coupled to an external driving device;
a decoder configured to decode the second data outputted from the memory unit; and
a driving controller configured to sequentially output decoded data of the decoder to the coupling unit in synchronization with a serial clock.

2. The RFID system according to claim 1, further comprising a serial clock generator configured to generate the serial clock.

3. The RFID system according to claim 1, wherein the second data is stored in a serial data format in the second address area.

4. The RFID system according to claim 3, wherein the first address area comprises a nonvolatile ferroelectric memory.

5. The RFID system according to claim 3, wherein the second address area comprises a register configured to store the second data.

6. The RFID system according to claim 5, wherein the second data are sequentially stored in the register according to the radio signal.

7. The RFID system according to claim 5, wherein the second data comprises a serial protocol signal including a slave address, a read component, a write component, and an acknowledge component.

8. The RFID system according to claim 7, wherein the slave address comprises a control component which determines a device type, and a chip select component which expands an address area.

9. The RFID system according to claim 1, further comprising:
a demodulator configured to demodulate the radio signal and generate the command signal;
a modulator configured to modulate a response signal applied from the digital unit, and output the modulated response signal to an antenna;
a power on reset unit configured to generate a power on reset signal to the digital unit; and
a clock generator configured to generate a clock signal to the digital unit.

10. The RFID system according to claim 1, wherein the coupling unit comprises:
a data pad configured to output a serial data outputted from the driving controller to the driving device; and
a clock pad configured to output the serial clock to the driving device.

11. The RFID system according to claim 1, wherein the driving device comprises a device which controls the driving of a light emitting diode (LED) using a serial interface protocol.

12. The RFID system according to claim 3, wherein the digital unit is configured to determine whether the command signal corresponds to the first address area or the second address area, and output the address corresponding to the first address area or the second address area to activate one of the first and second address areas.

13. The RFID system according to claim 1, further comprising:
a power supply voltage pad configured to supply a power supply voltage to an RFID chip; and
a ground voltage pad configured to supply a ground voltage to the RFID chip.
